(19) United States
(12) Patent Application Publication
(10) Pub. No.: US 2004/0024696 A1
(43) Pub. Date: Feb. 5, 2004

(54) System for automatically transferring funds

(76) Inventor: Federico Alves, Sunrise, FL (US)

Correspondence Address: RICHARD D. FUERLE, 1711 W. RIVER RD., GRAND ISLAND, NY, 14072, US

(21) Appl. No.: 10/064,648

(22) Filed: Aug. 2, 2002

(51) Int. Cl. G06F 17/60

(52) U.S. Cl. 705/39

(57) ABSTRACT

A system enables a payer to transfer funds to a payee. The system includes a first location where a payee can purchase a payee card and a second location where a payer can purchase a payer card for transferring a designated amount of money. The system also includes a central processor that can approve or reject a transfer of money from the payer to the payee, notify an AVRS of whether the requested transfer has been approved or rejected, and authorize an ATM to pay out money. An AVRS in the system can, when called by the payer, transmit information from the payer to the central processor and notify the payer whether a requested transfer is approved or rejected. Finally, at least one ATM in the system can pay out money if the requested transfer is approved.

### BACKGROUND OF INVENTION

This invention relates to a system that enables a payer to transfer funds to a payee without dealing with a bank and without the need for any clerical personnel other than a salesperson. In particular, a payee buys a payee card having a payee PIN, a payer buys a payer card in the amount he wishes to transfer to the payee, which has a payer PIN, the payer calls an automatic voice response system (AVRS) and enters the two PINs and the amount to be transferred, and the payee can then obtain the transferred amount from an automatic teller machine (ATM).

As commerce has increased between remote locations, such as between different nations, the need to send funds to remote locations has also increased. Immigration too has increased and immigrants frequently want to send funds back to their native country. An inexpensive and easily-used method of transferring funds would be highly beneficial.

There are presently a number of ways that funds can be transferred between remote locations. Checks can be mailed, but several days are required for a check to be delivered and in some countries checks are stolen from the mail and never arrive. After a check is received, an additional 15 to 60 days may be required for it to clear. Also, to send a check, the sender must have a bank account and the recipient must either have a bank account also or must use a costly check-cashing service. Money can also be wired, but both the sender and the recipient must have a bank account. Many people do not feel comfortable using a bank and do not have a bank account. Another option is to use a service such as Western Union. While Western Union does not require bank accounts, it is an expensive method of transferring funds because a clerk is required at both locations of the transfer to obtain the needed information and to enter it into Western Union's worldwide on-line database.

### SUMMARY OF INVENTION

In the system of this invention, money can be transferred from a payer to a payee at a remote location without either party having a bank account. Indeed, there is no need for either party to even go into a bank. The parties simply purchase cards that entitle the payer to transfer a specified amount of money to the payee. Any store clerk can sell the cards and there is no need for the clerk to have any expertise in filling out forms. Nor it is necessary for the clerk to enter data into a central processor or collect or provide any information about the persons who purchase the cards. The funds can be transferred in less than an hour by simply making a few telephone calls and can be picked up at an ATM.

### DETAILED DESCRIPTION

Four elements are used in the system of this invention: (1) stores to sell payer cards and payee cards; (2) an AVRS that can receive information from and transmit information to a payer; (3) a central processor that maintains a database of payer and payee accounts and can determine if a proposed transfer of funds is acceptable and authorize payment; and (4) an ATM that can dispense the funds. If the ATM is controlled by a bank, rather than directly by the central processor, a bank will also be part of the system. And, if the system provides long distance calling to the payee and/or the payer at no additional charge, a long distance telephone service will also be part of the system.

Stores that desire to participate in the system will sell payee cards and/or payer cards. The system operator supplies participating stores with payer cards and payee cards to sell, keeping a record of the cards that are in each store. That information is entered into the central processor. To induce a store to participate in the system, a store can be permitted to keep the money received when a payer card is purchased for a number of business days (such as about 10) before the store must pay the designated value of the payer card to the system operator. In addition, a store can be permitted to sell a payee card for an amount (such as one dollar) over what it pays the system operator for a payee card.

While stolen payee cards cannot be used to obtain funds, stolen payer cards could be used to send money to accomplices who have purchased payee cards. For that reason, it is necessary for stores selling payer cards to treat the cards as though they were cash and keep them in a secure location. Preferably, the system will not release funds at an ATM for a short period of time (preferably about ½ hour to about 1 hour) after the payer has called the AVRS and the transfer has been approved. In that way, if a payer card is stolen in a holdup, a store employee can call an authorized telephone number and the stolen card can be removed from the system by deleting its PIN from the payer account, or, equivalently, by flagging the PIN so that it cannot be identified with that account. As a result, the stolen payer card cannot be used to transfer funds.

If a payer wants to send money to a payee, the payee goes into a participating store and buys a payee card. A payee card is a plastic card that can be inserted into an ATM. The payee card is encoded with an encoded identifying number that can be read by an ATM, preferably on a magnetic tape, though other types of ATM-readable encoded identifying numbers could also be used. The payee card also has a PIN printed on it that can be read by the payee. A removable tape preferably conceals the PIN to prevent non-purchasers from seeing it. Also, to prevent fraud, the tape is preferably not replaceable so that it cannot be removed, read by a non-purchaser, and replaced. The encoded identifying number on the payee card is preferably different from the payee's PIN in order to discourage fraud. Both the identifying number and the payee's PIN are linked to the payee account in the database. The payee removes the tape, and transmits the PIN underneath the tape to the payer. This he can do by any method he wishes to, such as by e-mail, telegraph, or telephone. However, the payee card is preferably provided with a toll-free number that he can call and, when prompted, enter his PIN and the payer's telephone number. If the PIN is in the database, he is connected to payer without any additional cost for a call of limited duration or value. The payee can make additional calls until he uses up the telephone time or value permitted by the card.

Before or after the payee purchases his payee card, the payer goes into a participating store and purchases a payer card. The payer cards can be sold in even denominations such as $50, $100, $150, $300, $500, etc., and the denomination can be printed on the card. The cost of the payer card to the payer will be the denominated value of the card plus a small additional amount. On each payer card, preferably concealed under a removable tape, is a payer PIN. Also on the payer card is the (preferably toll-free) telephone number of an AVRS.

The payer calls the AVRS and the AVRS prompts him to enter the payer's PIN, the payee's PIN, and the amount of money he wishes to transfer. The AVRS transmits this information to a central processor. The central processor has in its database a payer account for each payer PIN. Each payer account contains the amount that can be used on the payer card having that PIN (initially, that amount will be the designated amount of the payer card), and the store that purchased that payer card. The central processor also has in its database a payee account for each identifying number on each payee card. Each payee account contains the PIN assigned to that identifying number, the amount in the account (initially zero, until a payer makes a transfer to that account), and the store that purchased that card. The central processor checks its database to determine if the payer's PIN is identified with a payer account and if the payee's PIN is identified with a payee account, and the amount of money in the payer account. If one or the other or both of the PINs are not identified with the proper account or the payer wants to transfer more money than is in his account, the central processor rejects the transfer, notifies the AVRS that the transfer has been rejected, and the AVRS notifies the payer. If the PINs are identified with the proper accounts and the amount the payer wants to transfer is in his account, the central processor notifies the AVRS that the transaction is approved and debits the payer account and credits the payee account for that amount. The AVRS informs the payer that the funds are available (or, preferably, that they will be available after the above-mentioned short time period) to the payee at a participating ATM In a preferred procedure, the AVRS then asks the payer if he would like to make a toll-free telephone call (of limited duration). If he does, the payer can immediately call the payee and tell him that he can pick up the funds. If the payer has transferred less than the full amount available on his card, the AVRS then asks the payer if would like to make another transfer of funds (normally to a different payee). If he would, the process is repeated. If not, the call is ended.

The payee goes to any participating ATM, inserts his payee card, and enters his PIN and the amount of money he wants to withdraw from his payee account. The ATM reads the encoded identifying number on the payee card and transmits that number, the payee's PIN, and the amount the payee wants to withdraw to the central processor.

The central processor determines whether the payee's PIN is identified with the payee account and whether the amount the payee wishes to withdraw exceeds the amount in the payee's account. If the PIN is correct and the money is in the payee account, the central processor debits the payee's account for that amount and authorizes the ATM to release the money. Otherwise, the transaction is ended.

If the system operator functions as a bank and directly operates the ATM, the funds dispensed by the ATM can come from a master account controlled by the system operator. If the ATM is controlled by a bank, the systems operator can have a master account at the bank (which can have sub-accounts for each payee) and the funds paid by the ATM can come from that account. If the payer and the payee are in different countries, the money dispensed by the ATM can be in the currency of the country in which it is located. If a currency conversion is needed, the amount of equivalent local currency will customarily be determined by the local bank that controls the ATM, using the current conversion rate.

As an additional embodiment of the system, the store selling a payer card could sell a card having any value designated by the payer (within certain limits). For example, if the payer wants to transfer exactly $503.87, he would pay the clerk in the store that amount plus a fee. The clerk would then call a special number given to her by the system operator and enter the PIN on the card and the amount designated, $503.87, and that amount would be entered into the payer's account by the central processor.

The following example further illustrates this invention.

### EXAMPLE

Bob, in New York City, wants to send $300 to Joe, in Rio de Janeiro and $200 to Carl in Mexico City. Joe purchases a payee card at a local store in Rio, paying $1.50. Joe dials the phone number on the card, reaching a long distance calling system. He enters Bob's telephone number and is connected to Bob. He tells Bob that the PIN on his card is 1234. Carl follows a similar procedure in Mexico City.

Bob goes to a store in New York City and purchases a $500 payer card, paying $505. Bob calls a toll-free AVRS number on the card and, when prompted by the AVRS, enters the PIN on his card, 5678, and also enters Joe's PIN, 1234. The AVRS tells him that there is $500 in his account and asks him how much he wants to transfer. Bob enters “300” and the AVRS tells him that the transaction is approved and that the money will be released in 2 hour. The AVRS asks if he wishes to make a phone call. Bob enters “Y” for “yes” and then enters Joe's telephone number. Bob tells Joe he can get the money in a 2 hour. Since Bob has time remaining on his card for another telephone call, he calls Carl and gives him the same message.

Joe goes to an ATM in Rio, inserts his payee card, enters his payee PIN, 1234, and the amount he wants, $200. The ATM gives Joe $200 and tells him he still has $100 in his account. Carl follows a similar procedure in Mexico City and retrieves $200 from an ATM there.

1. A method of enabling a payer to transfer funds to a payee comprising
(A) providing a first location where a payee can purchase a payee card;
(B) providing a second location where a payer can purchase a payer card for transferring a designated amount of money;
(C) providing a central processor that can
(1) approve or reject a transfer of money from said payer to said payee;
(2) notify an AVRS of whether said transfer has been approved or rejected; and
(3) authorize an ATM to pay out money;
(d) providing an AVRS that can, when called by said payer,
(1) transmit information from said payer to said central processor; and
(2) notify said payer whether a requested transfer is approved or rejected; and
(e) providing at least one ATM that can pay out money when said payee card is inserted into it and said central processor authorizes payment.

2. A method according to claim 1 wherein said designated amount of money is predetermined and is printed on said payer card.

3. A method according to claim 1 wherein said designated amount of money is determined by said payer.

4. A method according to claim 1 wherein said AVRS permits said payer to make a telephone call at no additional charge.

5. A method according to claim 1 wherein said payee card has a telephone number printed on it that permits said payee to make a telephone call at no additional charge.

6. A method according to claim 1 wherein said first location and said second location are in different countries.

7. A method according to claim 1 wherein said payer can transfer less than said designated amount of money.

8. A method according to claim 1 wherein said ATM can pay out less than the amount of money transferred.

9. A system for enabling a payer to transfer money to a payee according to the method of claim 1 comprising said first location, said second location, said central processor, said AVRS, and said ATM.

10. A method of enabling a payer to transfer funds to a payee comprising
(A) providing a first location where a payee can purchase a payee card having an encoded identifying number that can be read by an ATM and having a first PIN printed thereon;
(B) providing a second location where a payer can purchase a payer card for transferring a first amount of money, where said payer card has a second PIN printed thereon;
(C) providing a central processor having a database that comprises a payee account identified with said first PIN and said encoded identifying number and a payer account identified with said second PIN, where said central processor can
(1) receive information from an AVRS, said information including said first and second PINs and a second amount of money, the amount that said payer would like to transfer;
(2) determine
(a) whether said payee account is identified with said first PIN and said payer account is identified with said second PIN; and
(b) a third amount of money, the amount in said payer account;
(3) notify said AVRS of said third amount;
(4) notify said AVRS that a transfer of said second amount is approved if said payee account is identified with said first PIN and said payer account is identified with said second PIN and said second amount does not exceed said third amount;
(5) authorize an ATM to pay out said second amount; and
(D) providing an AVRS that can, when called by a payer,
(1) receive from said payer information that comprises said first and second PINs and said second amount and transmit that information to said central processor;
(2) inform said payer of said third amount; and
(3) inform said payer whether the transfer of said second amount is approved;
(E) providing at least one ATM that can pay out money when
(1) said payee card is inserted into said ATM;
(2) said first PIN is entered into said ATM; and
(3) said central processor authorizes payment.

11. A method according to claim 10 wherein said encoded identifying number is covered by a removable tape that, once removed, cannot be replaced.

12. A method according to claim 10 wherein said first amount of money is printed on said payer card.

13. A method according to claim 10 wherein said central processor can withhold authorization of said transfer if said payer card is reported stolen.

14. A method according to claim 10 wherein said central processor does not authorize said ATM to make said payment until about ½ hour to about 1 hour after said central processor receives said information.

15. A method according to claim 10 wherein said encoded identifying number is on a magnetic strip.

16. A system for enabling a payer to transfer money to a payee according to the method of claim 10 comprising said first location, said second location, said central processor, said AVRS, and said ATM.

17. A method of enabling a payer to transfer funds to a payee comprising
(A) providing a first location where a payee can purchase a payee card having
(1) a magnetically-encoded identifying number that can be read by an ATM;
(2) a first PIN printed thereon; and
(3) a first telephone number printed thereon;
(B) providing a second location where a payer can purchase a payer card for transferring a first amount of money, where said payer card has a second PIN and a second telephone number printed thereon;
(C) providing a central processor having a database that comprises
(1) a payee account identified with said first PIN, said first location, said magnetically-encoded identifying number, and a second amount, where said second amount is the amount in the account; and
(2) a payer account identified with said second PIN, said second location, and a third amount, where said third amount is the amount in said payer account;
where said central processor can
(1) receive information from an AVRS, said information including said first and second PINs and a fourth amount of money, where said fourth amount is the amount that said payer would like to transfer;
(2) determine
(a) if said payee account is identified with said first PIN and said payer account is identified with said second PIN; and
(b) whether said fourth amount exceeds said third amount;
(3) notify said AVRS of said third amount;
(4) notify said AVRS that a transfer of said fourth amount is approved if
(a) said payee account is identified with said first PIN and said payer account is identified with said second PIN; and
(b) said fourth amount does not exceed said third amount; and
(5) if said transfer is approved, debit said payer account and credit said payee account for said fourth amount;
(6) receive information from an ATM, said information comprising
(a) said magnetically-encoded identifying number;
(b) said first PIN; and
(c) a fifth amount of money, where said fifth amount is the amount that said payee wishes to withdraw from said payee account;
(7) determine whether said fifth amount exceeds said second amount;
(8) authorize a bank to pay out said fifth amount from said ATM when said fifth amount does not exceed said second amount; and
(9) debit said payee account by said fifth amount;
(D) providing an AVRS that can, when called by a payer,
(1) receive from said payer information that comprises said first and second PINs and said fourth amount and transmit said information to said central processor; and
(2) inform said payer whether the transfer of said fourth amount is approved;
(E) providing a bank that can, when authorized to do so by said central processor, direct at least one ATM to pay out said fifth amount; and
(E) providing at least one ATM that can pay out said fifth amount when
(1) said payee card is inserted into said ATM;
(2) said first PIN is entered into said ATM; and
(3) said ATM is directed to pay out said fifth amount by said bank.

18. A method according to claim 17 wherein said central processor can withhold authorization of said transfer if said payer card is reported stolen.

19. A method according to claim 17 wherein said central processor does not authorize said bank to make said payment until about ½ hour to about 1 hour after said central processor receives said information.

20. A system for enabling a payer to transfer money to a payee according to the method of claim 17 comprising said first location, said second location, said central processor, said AVRS, said bank, and said ATM.
